(19) United States
(12) Patent Application Publication
(10) Pub. No.: US 2026/0167780 A1
(43) Pub. Date: Jun. 18, 2026

(54) Silicone Hydrogel Mixture and Wettable Silicone Hydrogel Lens Formed Thereof

(71) Applicant: LUCENS TECHNOLOGY INC., Taoyuan City (TW)

(72) Inventor: Kuo Teng HSU, Taoyuan City (TW)

(21) Appl. No.: 19/175,207

(22) Filed: Apr. 10, 2025

(30) Foreign Application Priority Data
Dec. 16, 2024 (TW) 113148952

(51) Int. Cl. C08J 3/075; C08F 230/08; C08J 3/24; C08L 35/02; G02B 1/04

(52) U.S. Cl. CPC C08J 3/075; C08F 230/085; C08J 3/246; C08L 35/02; G02B 1/043; C08J 2343/04; C08J 2439/06

(57) ABSTRACT

A silicone hydrogel mixture and a wettable silicone hydrogel lens formed thereof. The silicone hydrogel mixture comprises a silicone macromer, a hydrophilic polymer, and a non-silicone hydrophilic crosslinking agent, wherein the non-silicone hydrophilic crosslinking agent is polyethylene glycol dimethacrylate (PEGDMA) represented by the following structural formula (A):

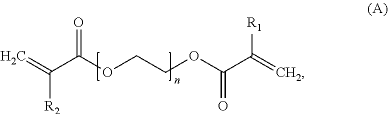

wherein R₁ and R₂ are CH₃ or R₁ and R₂ are H, and n is an integer from 4 to 42.

### FIELD OF THE INVENTION

The present invention relates to a silicone hydrogel lens and more particularly to a silicone hydrogel mixture and the silicone hydrogel lens that has wettability without any surface treatment.

### BACKGROUND OF THE INVENTION

Contact lenses are worn directly on the cornea of the eye, and the cornea requires a sufficient oxygen supply to remain healthy. The cornea has no blood vessels and needs to obtain oxygen from the dissolved oxygen in the tear film on the surface of the cornea. Contact lenses block the contact between tears and air, reducing the dissolved oxygen content of tears. In addition, wearing contact lenses for a long time can also affect the secretion of tears, causing dryness of eyes and even causing eye problems such as dry eye syndrome and keratitis. Therefore, the oxygen permeability and wetness of contact lenses are crucial to eye health.

Traditional hydrogel contact lenses are mainly made of highly hydrophilic poly(hydroxyethyl methacrylate) (poly-HEMA). The oxygen permeability (Dk/t) of poly-HEMA is approximately between 20 and 30. Long-term wearing of poly-HEMA contact lenses can easily cause corneal hypoxia, which leads to the above-mentioned eye problems. In order to improve the oxygen permeability of contact lenses, contact lenses made of silicone hydrogel have been developed. Silicone hydrogel is made by adding silicon to hydrogel. Silicon molecules can form pores in the material to allow oxygen passing through, so it has a high oxygen permeability. The oxygen permeability of silicone hydrogel contact lenses can reach over 100 Dk/t, making them more suitable for long-term wear. Their high oxygen permeability can reduce the chance of eye problems such as keratitis.

However, silicone hydrogel is a hydrophobic material and its surface is not easy to be wetted. Directly wearing contact lenses made of hydrophobic materials would cause eye discomfort to the user. Moreover, hydrophobic contact lenses can easily absorb lipids and cause protein deposition. For solving this problem, a variety of methods for modifying the surface of silicone hydrogel lenses have been developed, for example, adsorbing hydrophilic components on the surface of silicone hydrogel lenses by surface coating, chemical adsorption or plasma technology, in order to make the surface of silicone hydrogel lenses wettable.

However, the manufacturing processes of these surface modification methods are too complicated and the production costs are relatively high. In order to simplify the manufacturing processes and reduce costs, the industry has developed a method of adding hydrophilic components in the process of manufacturing lens materials, so that the formed lens materials themselves are wettable and do not require additional surface modification processes.

However, the surface hydrophilicity of existing wettable silicone hydrogel lenses still needs to be improved. In order to provide users with a more comfortable wearing experience and extend the wearing time, the industry still needs technical solutions for improving the hydrophilicity of silicone hydrogel lenses.

### SUMMARY OF THE INVENTION

Therefore, how to improve the water affinity of the surface of the silicone hydrogel lenses in order to provide users with more comfortable wearing experience and extend the wearing time is an important issue in the related industries. Accordingly, in order to solve the above-mentioned problem, extensive research and experiments were conducted by the applicant of the present application in order to provide silicone hydrogel lenses with higher surface affinity to water.

The object of the present invention is to provide a silicone hydrogel mixture for forming a wettable silicone hydrogel lens and a wettable silicone hydrogel lens formed by the silicone hydrogel mixture. The surface of the lens thus formed has excellent water affinity and the wettability of the lens surface can be improved effectively, providing user with a more comfortable wearing experience and extending the wearing time.

In order to achieve the above-mentioned object, the present invention provides a silicone hydrogel mixture for forming a wettable silicone hydrogel lens. The silicone hydrogel mixture comprises a silicone macromer, a hydrophilic polymer, and a non-silicone hydrophilic crosslinking agent, wherein the non-silicone hydrophilic crosslinking agent is polyethylene glycol dimethacrylate (PEGDMA) represented by the following structural formula (A):

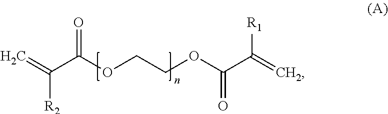

wherein R₁ and R₂ are CH₃ or R₁ and R₂ are H, and n is an integer from 4 to 42.

Moreover, the present invention provides a wettable silicone hydrogel lens formed of the above-mentioned silicone hydrogel mixture.

In implementation, the content of the polyethylene glycol dimethacrylate (PEGDMA) is 2% to 15% by weight of the silicone hydrogel mixture.

In implementation, the wettable silicone hydrogel lens has a dynamic contact angle less than or equal to 50°.

Compared with existing technology, the wettable silicone hydrogel lens formed of the silicone hydrogel mixture provided by the present invention has a smaller droplet contact angle and can indeed improve the water affinity of the surface of the lenses.

### DETAILED DESCRIPTIONS OF PREFERRED EMBODIMENTS

The present invention is related to a silicone hydrogel mixture for forming a wettable silicone hydrogel lens. The silicone hydrogel mixture of the present invention comprises a silicone macromer, a hydrophilic polymer, and a non-silicone hydrophilic crosslinking agent, wherein the non-silicone hydrophilic crosslinking agent is polyethylene glycol dimethacrylate (PEGDMA) represented by the following structural formula (A):

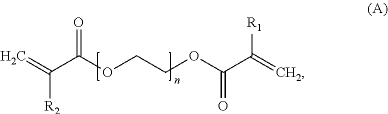

wherein R₁ and R₂ are CH₃ or R₁ and R₂ are H, and n is an integer from 4 to 42.

Moreover, the present invention provides a wettable silicone hydrogel lens formed of the above-mentioned silicone hydrogel mixture.

In some embodiments, the content of the polyethylene glycol dimethacrylate (PEGDMA) is 2% to 15% by weight of the silicone hydrogel mixture.

In some embodiments, the content of the silicone macromer is preferably 5% to 50%, more preferably 15% to 50%, or even more preferably 25% to 50% by weight of the silicone hydrogel mixture.

In some embodiments, the silicone macromer comprises (3-methacryloxy-2-hydroxypropoxy)propylbis(trimethylsiloxy) methylsilane (SiGMA) represented by the following structural formula (B):

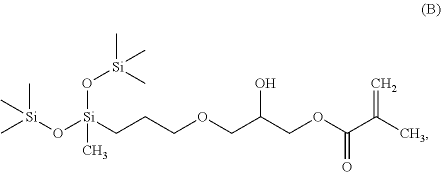 [SMILES: C=C(C)C(=O)OCC(O)COCCC[Si](C)(O[Si](C)(C)C)O[Si](C)(C)C]

and the content of (3-methacryloxy-2-hydroxypropoxy)propylbis(trimethylsiloxy) methylsilane (SiGMA) is preferably 5% to 40% by weight of the silicone hydrogel mixture.

In some embodiments, the hydrophilic polymer may be polyvinylpyrrolidone (PVP), and the content of PVP is preferably 0.1% to 10% by weight of the silicone hydrogel mixture.

The average molecular weight of polyvinylpyrrolidone (PVP) is measured by gel permeation chromatography (GPC). The measured average molecular weight is usually represented by a K value. The K value of the PVP used in the present invention is 90.

In the silicone hydrogel mixture, the polymer chains of polyvinylpyrrolidone (PVP) may form interpenetrating polymer network (IPN) structure and/or semi-interpenetrating polymer network (semi-IPN) structure with the three-dimensional network formed by the silicone macromer. An interpenetrating polymer network (TPN) refers to a structure formed by two or more network structures formed by polymers at least partially interpenetrating at the polymer scale. A polymer network structure is formed by covalently bonded polymers, while there is no covalent bond between the polymers in an interpenetrating network structure. Nevertheless, the IPN structure is difficult to separate unless the chemical bonds in the network are broken. In addition, there is also a so-called semi-IPN structure, which is characterized by a structure formed by one or more networks and one or more linear or branched polymers interpenetrating at the polymer scale, and there are no covalent bonds between the interpenetrating polymers.

In some embodiments, the silicone hydrogel mixture may further comprise another hydrophilic polymer, which may form a polymer entanglement with polyvinylpyrrolidone (PVP) in the above-mentioned interpenetrating polymer network and/or a semi-interpenetrating polymer network, so that PVP is more stable in the IPN structure or semi-IPN structure and is not easy to fall off. A polymer entanglement refers to the network or spherical structure formed by the cross-linking points within a polymer chain or between polymer chains, which prevents the polymer chains from moving normally and thus affects the properties of the polymer.

In some embodiments, the other hydrophilic polymer may be formed by 1-Vinyl-2-pyrrolidinone (NVP) monomer, and its content is preferably 5% to 40% by weight of the silicone hydrogel mixture.

The wettability (hydrophilicity) of a material surface is usually determined by the angle formed by the liquid/gas interface of a droplet on the material surface. This angle is usually called the dynamic contact angle (DCA). The smaller the dynamic contact angle, the more hydrophilic the material surface is. The dynamic contact angle of a hydrophobic material surface is greater than 90°.

The wettable silicone hydrogel lens formed from the silicone hydrogel mixture of the present invention preferably has a dynamic contact angle less than or equal to 70°, more preferably has a dynamic contact angle less than or equal to 60°, or even more preferably has a dynamic contact angle less than or equal to 50°.

Several examples are listed below to specifically illustrate the compositions and effects of the mixture of the present invention, but these examples are not intended to limit the present invention. The abbreviations of the compounds used in the examples are listed in Table 1.

TABLE 1

| abbreviation | Chemical formula |
|---|---|
| SiGMA | (3-Methacryloxy-2-hydroxypropoxy)propylbis(trimethylsiloxy) |
| | methylsilane |
| mPDMS | Monomethacryloxypropyl Terminated Polydimethylsiloxane (n = 11) |
| DMA | N,N-Dimethylacrylamide |
| HEMA | 2-hydroxyethyl methacrylate |
| NVP | 1-Vinyl-2-pyrrolidinone |
| UVA | 2-[3-(2H-Benzotriazol-2-yl)-4-hydroxyphenyl]ethyl methacrylate |
| EGDMA | Ethylene glycol dimethacrylate |
| TEGDMA | Triethylene glycol dimethacrylate |
| PEGDMA330 | Poly(ethylene glycol) dimethacrylate (n = 4) |
| PEGDMA550 | Poly(ethylene glycol) dimethacrylate (n = 9) |
| PEGDMA750 | Poly(ethylene glycol) dimethacrylate (n = 14) |
| PEGDMA2000 | Poly(ethylene glycol) dimethacrylate (n = 42) |
| AIBN | 2,2′-Azobis(2-methylpropionitrile) |
| PVP | Polyvinylpyrrolidone (K value 90) |
| RB246 | 1,4-Bis(4-(2-methacryloxyethyl)phenylamino)anthraquinone |
| TAA | 2-Methyl-2-butanol |

Tables 2 and 3 list the reaction components and results of the silicone hydrogel mixtures of Examples 1 to 11, in which Examples 1 to 7 are comparative examples, and Examples 8 to 11 are embodiments of the present invention. The unit of the content of each reaction component listed in the tables is weight percent.

TABLE 2

| Example | 1 | 2 | 3 | 4 | 5 | 6 |
|---|---|---|---|---|---|---|
| SiGMA | 22.9 | 22.9 | 22.9 | 22.8 | 22.3 | 21.8 |
| mPDMS | 22.9 | 22.9 | 22.9 | 22.8 | 22.3 | 21.8 |
| DMA | 6.9 | 5.8 | 4.6 | 4.6 | 4.5 | 4.4 |
| HEMA | 6.9 | 8.0 | 9.2 | 9.1 | 8.9 | 8.7 |
| NVP | 29.3 | 29.3 | 29.3 | 29.2 | 29.9 | 30.6 |
| EGDMA | 2.8 | 2.8 | 2.8 | 3.2 | 3.1 | 3.1 |
| PVP | 3.7 | 3.7 | 3.7 | 3.7 | 4.5 | 5.2 |
| AIBN | 3.2 | 3.2 | 3.2 | 3.2 | 3.1 | 3.1 |
| UVA | 1.4 | 1.4 | 1.4 | 1.4 | 1.3 | 1.3 |
| RB246 | 0.03 | 0.03 | 0.03 | 0.03 | 0.03 | 0.03 |
| TAA | 28.5 | 28.5 | 28.5 | 28.5 | 28.5 | 28.5 |
| DCA | 74.42 | 64.93 | 57.73 | 58.38 | 57.73 | 56.93 |
| DK | 88.1 | 96.0 | 97.9 | 97.6 | 95.1 | 96.7 |
| VLT | 79.2% | 85.1% | 94.6% | 94.3% | 93.7% | 93.2% |

TABLE 3

| Example | 6 | 7 | 8 | 9 | 10 | 11 |
|---|---|---|---|---|---|---|
| SiGMA | 21.8 | 21.5 | 21.4 | 24.3 | 23.8 | 22.5 |
| mPDMS | 21.8 | 21.5 | 21.4 | 18.6 | 18.2 | 17.2 |
| DMA | 4.4 | 4.3 | 4.3 | 3.8 | 3.7 | 3.5 |
| HEMA | 8.7 | 8.6 | 8.5 | 11.4 | 11.1 | 10.5 |
| NVP | 30.6 | 30.2 | 29.9 | 26.6 | 26.0 | 24.6 |
| EGDMA | 3.1 | 0.0 | 0.0 | 0.0 | 0.0 | 0.0 |
| TEGDMA | 0.0 | 4.3 | 0.0 | 0.0 | 0.0 | 0.0 |
| PEGDMA330 | 0.0 | 0.0 | 5.1 | 0.0 | 0.0 | 0.0 |
| PEGDMA550 | 0.0 | 0.0 | 0.0 | 6.8 | 0.0 | 0.0 |
| PEGDMA750 | 0.0 | 0.0 | 0.0 | 0.0 | 8.9 | 0.0 |
| PEGDMA2000 | 0.0 | 0.0 | 0.0 | 0.0 | 0.0 | 14.0 |
| PVP | 5.2 | 5.2 | 5.1 | 4.6 | 4.5 | 4.2 |
| AIBN | 3.1 | 3.0 | 3.0 | 2.7 | 2.6 | 2.5 |
| UVA | 1.3 | 1.3 | 1.3 | 1.1 | 1.1 | 1.1 |
| RB246 | 0.03 | 0.03 | 0.03 | 0.03 | 0.03 | 0.03 |
| TAA | 28.5 | 28.5 | 28.5 | 28.5 | 28.5 | 28.5 |
| DCA | 56.93 | 55.40 | 49.69 | 46.20 | 47.70 | 46.67 |
| DK | 96.7 | 93.2 | 88.5 | 110.7 | 103.2 | 98.6 |
| VLT | 93.2% | 92.9% | 92.6% | 93.2% | 93.5% | 93.2% |

The examples of silicone hydrogel lens listed in Tables 2 and 3 were prepared in the following manner: the reaction components and diluent (TAA) listed in Tables 2 and 3 were mixed together by means of stirring or rolling for at least about 12 hours at about 23° C., until all components were dissolved. The contents of the reactive components are reported as the weight percent of all reactive components except the diluent (TAA) and the reactive dye (RB246), and the contents of the diluent (TAA) and the reactive dye (RB246) are reported as the weight percent of the final reaction mixture. The mixed reaction mixture was placed into thermoplastic contact lens molds for curing. The curing process includes the following steps: first purging the mold in nitrogen for 1 hour, then heating the mold to 90° C. with the temperature ramp of 45° C./min, and followed by curing the lenses at 90° C. for 24 hours. The O₂ concentration in the curing oven is preferably less than 500 ppm, and more preferably less than 100 ppm. The molds were opened and the cured lenses were extracted into borate buffered saline, and soaked therein for about 3 hours at 80° C. to remove the residual diluent and monomers. The characteristics of the resulting lenses are shown in Tables 2 and 3.

Tables 2 and 3 list three characteristics measured on the resulting lenses: the dynamic contact angles (DCA), the oxygen permeability (Dk), and the visible light transmittance (VLT).

Dynamic contact angles (DCA) were measured by using a DSA25 Drop Shape Analyzer (KRUSS Optronic) with contact lens adaptor. Lenses were equilibrated and measured in borate buffered saline. Oxygen permeability is measured by using a Rheder O₂ Permeometer model 201T using the method described in the international standard ISO 9913-1. Visible light transmittance (VLT) is measured by using a spectrophotometer.

The main differences between Example 1 to 6 (the comparative examples) are the different contents of DMA, HEMA, and PVP in the reaction components. The lower part of Table 2 list the measurement results of the characteristics of the lenses of Example 1 to 6. The results show that the visible light transmittance of the lenses can be improved by increasing the HEMA content.

Table 3 lists the results of Example 8 to 11. For the convenience of comparison, the results of Examples 6 and 7 (the comparative examples) are also listed in Table 3. The main difference between the mixture formulas of Examples 6 to 11 is the use of non-silicone crosslinking agents with different polymerization degrees n. The crosslinking agent used in Example 6 (the comparative example) is EGDMA (n=1); the crosslinking agent used in Example 7 (the comparative example) is TEGDMA (n=3); and the crosslinking agents used in Examples 8 to 11 are PEGDMA330 (n=4), PEGDMA550 (n=9), PEGDMA750 (n=14), and PEGDMA2000 (n=42), respectively. The measurement results of the characteristics listed in Table 3 show that the silicone hydrogel lenses provided by Examples 8 to 11 have good performance in various characteristics, including dynamic good contact angles, appropriate oxygen permeability and transparency. In particular, the measurement results of the dynamic contact angle show that, compared with Examples 1 to 7, the dynamic contact angles of Examples 8 to 11 are all less than 50°, which are significantly lower than the dynamic contact angles measured in Examples 1 to 7, indicating that the silicone hydrogel mixture provided by the present invention can obviously improve the hydrophilicity of the lens.

Therefore, the silicone hydrogel mixture provided by the present invention and the wettable silicone hydrogel lens made of the mixture can achieve the object of the present invention, that is, to provide lens of better hydrophilicity and to effectively improve the wettability of the lens surface, thereby providing users with a more comfortable wearing experience and extending the wearing time.

In addition, the wettable silicone hydrogel lens provided by the present invention can effectively reduce the use of organic solvents in the manufacturing process and thus can greatly simplify the recycling process of waste organic solvents. Therefore, the manufacturing process is not only more environmentally friendly, but also cost saving.

The above detailed description is for the preferred embodiment of the present invention, and its formula and process conditions are easily available to those skilled in the art. However, the embodiments of the present invention may be modified into various other forms, and the scope of the present invention is not limited to the embodiments described above. Therefore, those skilled in the art may make appropriate changes or improvements to the above embodiments based on the knowledge in the art without departing from the scope of the present invention.

What is claimed is:

1. A silicone hydrogel mixture for forming a wettable silicone hydrogel lens, the silicone hydrogel mixture comprising:
a silicone macromer;
a hydrophilic polymer; and
a non-silicone hydrophilic crosslinking agent, wherein the non-silicone hydrophilic crosslinking agent is polyethylene glycol dimethacrylate (PEGDMA) represented by following structural formula (A): 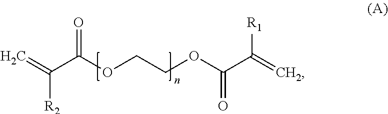
wherein R₁ and R₂ are CH₃ or R₁ and R₂ are H, and n is an integer from 4 to 42.

2. The silicone hydrogel mixture according to claim 1, wherein the content of the silicone macromer is 5% to 50% by weight of the silicone hydrogel mixture.

3. The silicone hydrogel mixture according to claim 1, wherein the silicone macromer comprises (3-methacryloxy-2-hydroxypropoxy)propylbis(trimethylsiloxy) methylsilane (SiGMA) represented by following structural formula (B): 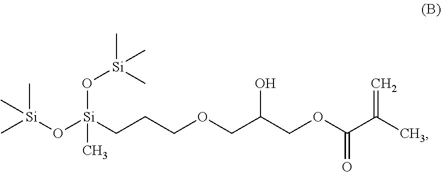 [SMILES: C=C(C)C(=O)OCC(O)COCCC[Si](C)(O[Si](C)(C)C)O[Si](C)(C)C]
and the content of SiGMA is 5% to 40% by weight of the silicone hydrogel mixture.

4. The silicone hydrogel mixture according to claim 1, wherein the hydrophilic polymer comprises a first hydrophilic polymer, and the first hydrophilic polymer is polyvinylpyrrolidone (PVP), and the content of PVP is 0.1% to 10% by weight of the silicone hydrogel mixture.

5. The silicone hydrogel mixture according to claim 4, wherein a K value of polyvinylpyrrolidone (PVP) is 90.

6. The silicone hydrogel mixture according to claim 4, when the silicone macromer forms a solid network, and the first hydrophilic polymer and the solid network formed by the silicone macromer form an interpenetrating polymer network and/or a semi-interpenetrating polymer network.

7. The silicone hydrogel mixture according to claim 6, wherein the hydrophilic polymer further comprises a second hydrophilic polymer, and the second hydrophilic polymer forms an entanglement with the first hydrophilic polymer in the interpenetrating polymer network and/or a semi-interpenetrating polymer network.

8. The silicone hydrogel mixture according to claim 4, wherein the hydrophilic polymer further comprises a second hydrophilic polymer, and the second hydrophilic polymer is formed by 1-Vinyl-2-pyrrolidinone (NVP) monomer, and the content of the second hydrophilic polymer is 5% to 40% by weight of the silicone hydrogel mixture.

9. The silicone hydrogel mixture according to claim 1, wherein the content of the polyethylene glycol dimethacrylate (PEGDMA) is 2% to 15% by weight of the silicone hydrogel mixture.

10. A wettable silicone hydrogel lens formed of a silicone hydrogel mixture, wherein the silicone hydrogel mixture comprises:
a silicone macromer;
a hydrophilic polymer; and
a non-silicone hydrophilic crosslinking agent, wherein the non-silicone hydrophilic crosslinking agent is polyethylene glycol dimethacrylate (PEGDMA) represented by following structural formula (A): 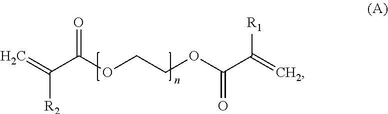
wherein R₁ and R₂ are CH₃ or R₁ and R₂ are H, and n is an integer from 4 to 42.

11. The wettable silicone hydrogel lens according to claim 10, wherein the content of the silicone macromer is 5% to 50% by weight of the silicone hydrogel mixture.

12. The wettable silicone hydrogel lens according to claim 10, wherein the silicone macromer comprises (3-methacryloxy-2-hydroxypropoxy)propylbis(trimethylsiloxy) methylsilane (SiGMA) represented by following structural formula (B): 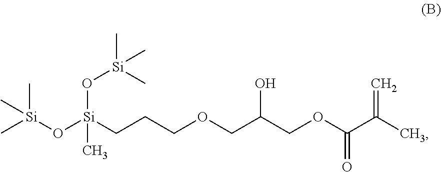 [SMILES: C=C(C)C(=O)OCC(O)COCCC[Si](C)(O[Si](C)(C)C)O[Si](C)(C)C]
and the content of SiGMA is 5% to 40% by weight of the silicone hydrogel mixture.

13. The wettable silicone hydrogel lens according to claim 10, wherein the hydrophilic polymer comprises a first hydrophilic polymer, and the first hydrophilic polymer is polyvinylpyrrolidone (PVP), and the content of PVP is 0.1% to 10% by weight of the silicone hydrogel mixture.

14. The wettable silicone hydrogel lens according to claim 13, wherein a K value of polyvinylpyrrolidone (PVP) is 90.

15. The wettable silicone hydrogel lens according to claim 13, when the silicone macromer forms a solid network, and the first hydrophilic polymer and the solid network formed by the silicone macromer form an interpenetrating polymer network and/or a semi-interpenetrating polymer network.

16. The wettable silicone hydrogel lens according to claim 15, wherein the hydrophilic polymer further comprises a second hydrophilic polymer, and the second hydrophilic polymer forms an entanglement with the first hydrophilic polymer in the interpenetrating polymer network and/or a semi-interpenetrating polymer network.

17. The wettable silicone hydrogel lens according to claim 13, wherein the hydrophilic polymer further comprises a second hydrophilic polymer, and the second hydrophilic polymer is formed by 1-Vinyl-2-pyrrolidinone (NVP) monomer, and the content of the second hydrophilic polymer is 5% to 40% by weight of the silicone hydrogel mixture.

18. The wettable silicone hydrogel lens according to claim 10, wherein the content of the polyethylene glycol dimethacrylate (PEGDMA) is 2% to 15% by weight of the silicone hydrogel mixture.

19. The wettable silicone hydrogel lens according to claim 10, wherein the wettable silicone hydrogel lens has a dynamic contact angle less than or equal to 50°.
